(19) United States
(12) Patent Application Publication
(10) Pub. No.: US 2022/0043698 A1
(43) Pub. Date: Feb. 10, 2022

(54) CONTENT REFERENCE MANAGEMENT SYSTEM

(71) Applicant: Citrix Systems, Inc., Fort Lauderdale, FL (US)

(72) Inventors: Ze Chen, Nanjing (CN); Tian Wang, Nanjing (CN); Zongpeng Qiao, Nanjing (CN)

(21) Appl. No.: 16/994,979

(22) Filed: Aug. 17, 2020

Related U.S. Application Data
(63) Continuation of application No. PCT/CN2020/107023, filed on Aug. 5, 2020.

(51) Int. Cl. G06F 9/54; G06F 16/23

(52) U.S. Cl. CPC G06F 9/542; G06F 16/2358

(57) ABSTRACT

A first disclosed method involves storing, by a computing system, data indicating that first content accessible by an endpoint device includes a reference to second content of a first application hosted on a remote computing device. The computing system receives an indication of an update to the second content, and sends a notification to cause the endpoint device to output an indicator of the update to the second content. A second disclosed method involves sending, by a first computing system to a second computing system, a request to register that first content accessible by an endpoint device includes a reference to second content of an application hosted on a remote computing device. The first computing system receives a notification of an update to the second content from the second computing system, and causes the endpoint device to output an indicator of the update in response to receiving the notification.

### CROSS-REFERENCE TO RELATED APPLICATIONS

This application is a continuation of and claims the benefit under 35 U.S.C. § 120 and 35 U.S.C. § 365(c) to International Application PCT/CN2020/107023, entitled CONTENT REFERENCE MANAGEMENT SYSTEM, with an international filing date of Aug. 5, 2020, the entire contents of which are incorporated herein by reference for all purposes.

### BACKGROUND

It is common for a document, message, software code, Web page, etc., to include a reference to another item of content. For example, when using a Confluence application, implementation documentation on one page of the application may include a reference link to design or conceptual documentation on another page of the application. As another example, a messaging application (e.g., Slack or Outlook) may include a reference to one or more documents on a file sharing system, such as Citrix ShareFile, e.g., by including in the message a link that can be used to access those documents. As yet another example, a first piece of software code may include a reference to another piece of software code as a dependency relationship defined within the first piece of code. As still another example, a Word document may include a reference to a Wikipedia page by including a link to the page. Or as even a further example, a legal brief may include a reference to a court case in a legal reporter. These are only a handful of examples. There are many, many more circumstances in which one item of content may include a reference to another item of content.

### SUMMARY

This Summary is provided to introduce a selection of concepts in a simplified form that are further described below in the Detailed Description. This Summary is not intended to identify key features or essential features, nor is it intended to limit the scope of the claims included herewith.

In some of the disclosed embodiments, a method involves storing, by a computing system, data indicating that first content accessible by an endpoint device includes a reference to second content of a first application hosted on a remote computing device. The computing system receives an indication of an update to the second content, and sends a notification to cause the endpoint device to output an indicator of the update to the second content.

In some disclosed embodiments, a system includes at least one processor, and at least one computer-readable medium encoded with instructions which, when executed by the at least one processor, cause the system to store data indicating that first content accessible by an endpoint device includes a reference to second content of a first application hosted on a remote computing device, to receive an indication of an update to the second content, and to send a notification to cause the endpoint device to output an indicator of the update to the second content.

In some disclosed embodiments, a method involves sending, by a first computing system to a second computing system, a request to register that first content accessible by an endpoint device includes a reference to second content of an application hosted on a remote computing device. The first computing system receives a notification of an update to the second content from the second computing system, and causes the endpoint device to output an indicator of the update in response to receiving the notification.

### BRIEF DESCRIPTION OF THE DRAWINGS

Objects, aspects, features, and advantages of embodiments disclosed herein will become more fully apparent from the following detailed description, the appended claims, and the accompanying figures in which like reference numerals identify similar or identical elements. Reference numerals that are introduced in the specification in association with a figure may be repeated in one or more subsequent figures without additional description in the specification in order to provide context for other features, and not every element may be labeled in every figure. The drawings are not necessarily to scale, emphasis instead being placed upon illustrating embodiments, principles and concepts. The drawings are not intended to limit the scope of the claims included herewith.

FIG. 1A is block diagram illustrating an example content reference management system that is configured in accordance with some aspects of the present disclosure;

FIG. 1B shows an example item of referring content that includes a reference to an item of referenced content, such as that shown in FIG. 1C;

FIG. 1C show an example item of referenced content that may be referred to using a reference included in an item of referring content, such as that shown in FIG. 1B;

FIG. 1D shows an example of how a reference in an item of referring content may be annotated to indicate one or more updates to the item of referenced content to which it refers;

FIG. 1E shows an example table that may be maintained by the reference manager shown in FIG. 1A to facilitate management of content references as described herein;

FIG. 2 is a diagram of a network environment in which some embodiments of the content reference management system disclosed herein may deployed;

FIG. 3 is a block diagram of a computing system that may be used to implement one or more of the components of the computing environment shown in FIG. 2 in accordance with some embodiments;

FIG. 4 is a schematic block diagram of a cloud computing environment in which various aspects of the disclosure may be implemented;

FIG. 5 shows a sequence diagram illustrating an example workflow involving the example components of the content reference management system shown in FIG. 1A;

FIG. 6 is a sequence diagram illustrating a first example implementation of the workflow shown in FIG. 5; and

FIG. 7 is a sequence diagram illustrating a first example implementation of the workflow shown in FIG. 5.

### DETAILED DESCRIPTION

For purposes of reading the description of the various embodiments below, the following descriptions of the sections of the specification and their respective contents may be helpful:

Section A provides an introduction to example embodiments of a content reference management system configured in accordance with some aspects of the present disclosure;

Section B describes a network environment which may be useful for practicing embodiments described herein;

Section C describes a computing system which may be useful for practicing embodiments described herein;

Section D describes embodiments of systems and methods for accessing computing resources using a cloud computing environment;

Section E provides a more detailed description of example embodiments of the content reference management system introduced above in Section A; and

Section F describes example implementations of methods, systems/devices, and computer-readable media in accordance with the present disclosure.

### A. Introduction to Illustrative Embodiments of a Content Reference Management System

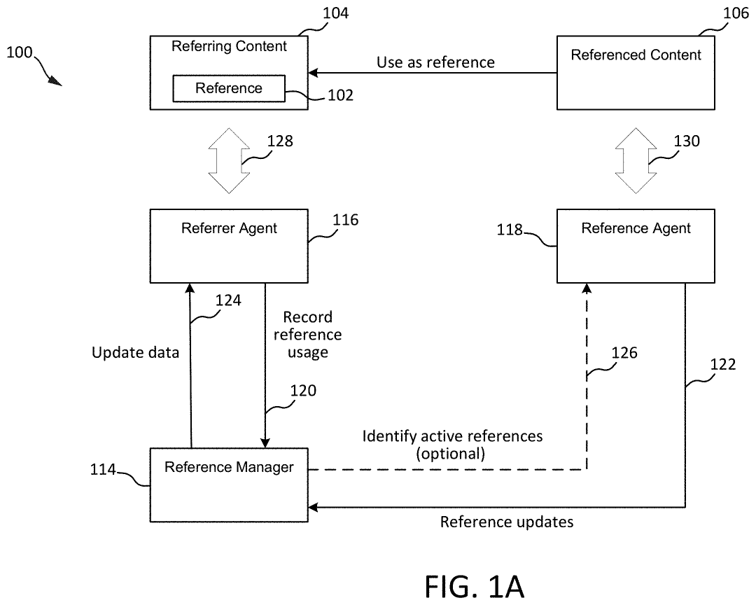

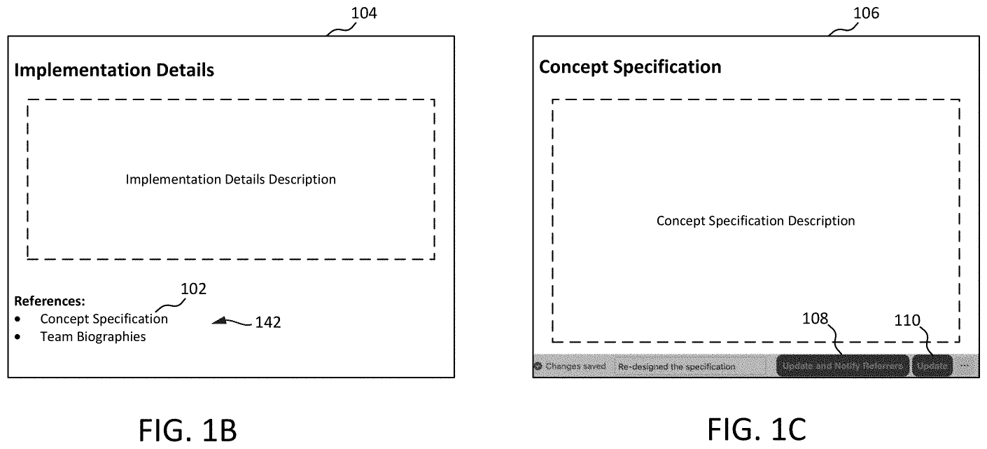

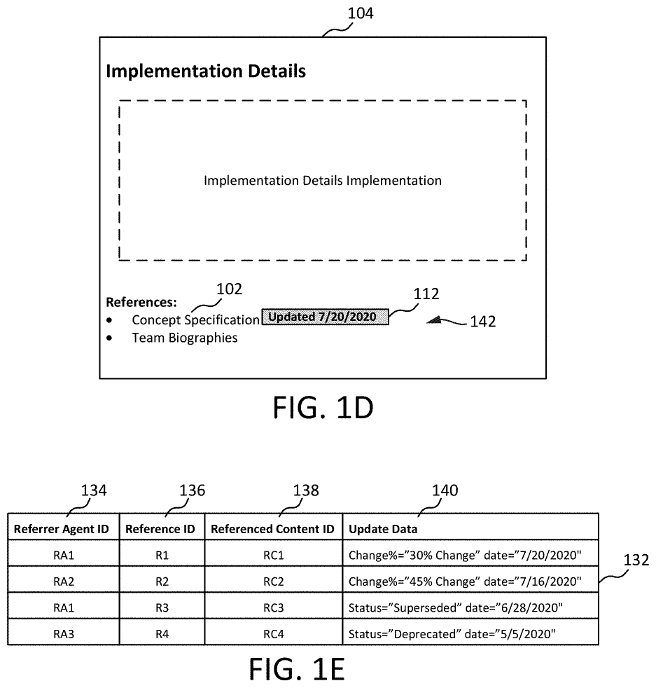

The inventors have recognized and appreciated that circumstances can arise in which a first item of content (referred to herein as “referring content”) may include a reference to another item of content (referred to herein as “referenced content”) and, unbeknownst to the author or user of the referring content, the referenced content may be edited or otherwise altered, or the status of the referenced content may change, e.g., it may be superseded, deprecated, deleted, overruled, or otherwise called into question. FIG. 1 illustrates an example scenario in which an item of referring content 104 may include a reference 102 to an item of referenced content 106. In some implementations, such a reference 102 may be selectable, e.g., it may be a link that can be clicked on or otherwise selected to access the referenced content 106 from the referring content 104. In other implementations, the reference 102 may be non-selectable, e.g., it may be simply a textual description of the referenced content 106. In still other implementations, the reference 102 may additionally or alternatively define a functional relationship between the referring content 104 and the referenced content 106, e.g., by specifying a dependency relationship between two pieces of software code.

An individual operating a client device (now shown in FIG. 1A) may access the referring content 104 and, based on the reference 102, may view, download, or otherwise access the referenced content 106. After such an individual has accessed the referenced content 106 on a first occasion, the referenced content 106 may be altered in some significant way or the status of the referenced content 106 may change significantly, e.g., a referenced standard specification may be superseded, a referenced piece of software code may be deprecated, a cited court case may be overruled, etc. Such events, i.e., when the referenced content 106 is altered or experiences a change of status, are collectively referred to herein as “updates” to the referenced content 106. When such an individual accesses the referring content 104 on subsequent occasions, the individual may be unaware that the referenced content 106 has been updated. That individual may thus mistakenly believe that the referenced content 106 is identical to the previously accessed version of the referenced content 106 and that the status of the referenced content 106 is unchanged. Such a mistaken understanding can, in at least some circumstances, lead to significant problems. For example, an author of implementation documentation in Confluence may generate such documentation based on stale design or conceptual documentation. As another example, a recipient of a message containing a link to one or more files on a file sharing system may take an inappropriate action because of a misunderstanding with respect to the nature and/or content of the files that are accessible using the link. As still another example, an author of a first piece of software code may have a mistaken understanding of the content or current status of another piece of software code with which the first piece of code has a dependency relationship. And as yet another example, an author of a legal brief may mistakenly believe that a cited legal authority remains good law when it has, in fact, been overruled by an appellate court.

Offered is a content reference management system 100 (an example of which is shown in FIG. 1A) for maintaining records concerning references 102 that are included in items of referring content 104 and apprising authors or users of the items of referring content 104 of at least certain types of updates that occur with respect to the referenced content 106. In some implementations, an individual who makes a change to the referenced content 106, and/or who determines that the status of the referenced content 106 has changed, may take an action, e.g., clicking a button, that causes the system 100 to present an indication of such an update to a user who subsequently accesses the referring content 104, e.g., by annotating the reference 102 within the referring content 104, or otherwise. In other implementations, the system 100 may additionally or alternatively detect updates to the referenced content 106 automatically, and, in at least some circumstances, e.g., when more than a threshold percentage of the referenced content 106 has changed, and/or when the system 100 determines that the status of the referenced content 106 makes it of questionable reliability, the system 100 may present an indication of the update to a user who subsequently accesses the referring content 104, e.g., by annotating the reference 102 within the referring content 104, or otherwise. An author or user of the referring content 104 may be notified of updates to items of referenced content 106 in any of number of ways. In some implementations, for example, the references 102 may be annotated within the items of referring content 104 to reflect such updates. Such annotations maybe introduced and/or presented to users in any of a number of ways to indicate that items of referenced content 106 have been updated. In some implementations, a warning icon may be presented adjacent a reference 102 that indicates the referenced content 106 to which it refers has been updated. In some implementations, additional information concerning the nature and/or extent of update may be presented in response to a selecting such an icon, e.g., by hovering a mouse cursor over it, clicking on it, tapping on it, etc. In other implementations, information concerning the nature and/or extent of the update may be presented without requiring such further user input.

FIG. 1B shows an example of how an item of referring content 104 may include a reference 102 to an item of referenced content 106 (shown in FIG. 1C) in accordance with some implementations. In the illustrated example, the item of referring content 104 may, for example, be a first page of a Confluence application that describes implementation details for a project, and the item of referenced content 106 may, for example, be a second page of the Confluence application that provides a concept specification for the project. As illustrated, in some implementations, the reference 102 may be added within a region 142 of the item of referring content 104 that is dedicated to identifying references to other content. Examples of techniques that may be used to add references 102 to items of referring content 104 and/or to register such references 102 with the system 100 so as to receive indications of updates to the referenced content 106 to which such references 102 refer are described below.

As shown in FIG. 1C, in some implementations, a user interface element 108, e.g., a button, an item on a dropdown menu, etc., may be presented in association with the referenced content 106 so as to allow a user who has made one or more changes to the item of referenced content 106, and/or determined that its status has changed, to not only cause such an update to take effect within the application that manages the content (e.g., Confluence), but also to cause one or more references 102 to the referenced content 106 that are included in items of referring content 104 to be annotated to indicate that the referenced content 106 has been updated. An example of such an annotation 112 is illustrated in FIG. 1D (described below). As indicated in FIG. 1C, in some implementations, the user may instead select a different user interface element 110, e.g., a button, an item of a drop-down menu, etc., so as to simply cause the update to take effect within the application that manages the content (e.g., Confluence), without causing one or more references 102 to the referenced content 106 to be annotated. Further, as noted previously, in some implementations, the system 100 may additionally or alternatively detect the occurrence of at least certain types of updates automatically, e.g., when more than a threshold percentage of the referenced content 106 has been changed or when a particular type of status change to the referenced content 106 is detected, and may cause one or more references 102 within the referring content 104 to be annotated in response to detecting such an occurrence.

As noted previously, FIG. 1D shows an example of an annotation 112 that may be presented adjacent or otherwise in association with a reference 102 within an item of referring content 104 to indicate that an item of referenced content 106 has been updated. In the illustrated example, the annotation 112 is included in the “references” region 142 of the item of referring content 104 and is displayed adjacent the reference 102. As shown, in some implementations, the annotation 112 may include an icon that indicates that the referenced content 106 has been updated, and may perhaps also indicate the date and/or time such an update took effect. In some implementations, such an icon may be selectable, e.g., by hovering over or clicking on it, and, when selected, may reveal (e.g., within a pop-up window) additional details concerning the nature and/or extent of the updates that occurred with respect to the referenced content 106. In other implementations, such additional details may be presented as part of the annotation 112 that is initially displayed, so that additional user input is not required to reveal them.

Referring again to FIG. 1A, in some implementations, the system 100 may include three components (including a reference manager 114, a referrer agent 116, and a reference agent 118) to facilitate the management of content references as described herein. The reference manager 114 may, for example, maintain records identifying various references 102 that the referrer agent(s) 116 have indicated are “active,” i.e., for which data concerning updates to the referenced content 106 to which such references 102 refer is to be provided. In some implementations, the reference manager 114 may be a cloud service or other server-based application that can be accessed over one or more networks.

As FIG. 1A illustrates, the reference manager 114 may interact separately with the referrer agent 116 and the reference agent 118 to achieve certain aspects of the functionality described herein. In particular, in some implementations, the reference manager 114 may receive “reference usage” messages 120 from the referrer agent 116 that request the reference manager 114 to record data indicating that references 102 to particular items of referenced content 106 have been included in items of referring content 104. For example, in some implementations, references 102 within items of referring content 104 may be “tagged” with identifiers of particular references 102 (referred to herein as “reference IDs”) that can be included in “reference usage” messages 120 together with identifiers of the referenced content 106 (referred to herein as “referenced content IDs”) to which such references 102 refer. The referenced content IDs may, for example, be uniform resource locators (URLs) from which items of referenced content 106 may be obtained or other identifiers indicating the particular items of referenced content 106 to which the references 102 refer. The references 102 may be tagged, for example, by embedding metadata indicating respective reference IDs into the referring content 104 at the locations of the references 102. In some implementations, such reference IDs may be determined by the reference manager 114 (e.g., to ensure they are unique within the system 100) and may be sent to the referrer agent 116 (e.g., when a new reference 102 is to be registered with the reference manager 114).

In other implementations, separate reference IDs may not be employed, and the “reference usage” messages 120 sent to the reference manager 114 may simply indicate the referenced content IDs for the references 102, e.g., URLs from which items of referenced content 106 may be obtained, that are to be registered with the reference manager 114. In some such implementations, such references 102 may be tagged with metadata indicating that they are “active,” such that the referrer agent 116 is aware that such references 102 are to be annotated based on updates to the items of referenced content 106 to which they refer, as described herein. In other such implementations, the mere fact that references 102 include referenced content IDs (e.g., URLs) for items of referenced content 106 may indicate that such references 102 are active.

In some implementations, the referrer agent 116 may tag and/or register (e.g., automatically tag and/or register) newly-added references 102 with the reference manager 114. For example, in some implementations, the referrer agent 116 may recognize links to certain sources of referenced content 106 that are added to items of referring content 104 and may automatically tag and/or register references 102 with the reference manager 114 in response to identifying such links. In other implementations, the referrer agent 116 may detect that a referenced content ID has been inserted into a particular region of the referring content 104 (e.g., within the “references” region 142 shown in FIG. 1B), and may automatically tag and/or register a new active reference 102 for the item of referenced content 106 identified by that referenced content ID in response to detecting such an insertion. In still other implementations, the referrer agent 116 may perform a tagging and/or registration process in response to user commands indicating that particular references 102 are to be registered with the reference manager 114. Each of these techniques is described in more detail below in Section E.

The reference manager 114 may, based on the received “reference usage” messages 120, create records, e.g., in a database (not shown in FIG. 1A), for the references 102 that are to be annotated when the items of referenced content 106 to which they refer are updated. In implementations in which references 102 are tagged with separate reference IDs, such records may further correlate those reference IDs with particular referenced content IDs (e.g., URLs or other identifiers of particular items of referenced content 106). As explained below, in some implementations (e.g., where multiple referrer agents 116 are employed and one or more new reference annotations are “pushed” to respective referrer agents 116), such “reference usage” messages 120 may additionally include information identifying the referrer agents 116 that manage the respective items of referring content 104, thus enabling the reference manager 114 to determine which referrer agents 116 are to receive the respective reference annotations.

An example table 132 that may be represented in a database of the reference manager 114 to maintain such records is shown in FIG. 1E. As shown in FIG. 1E, in some implementations, for respective “reference usage” messages 120 that are received from one or more referrer agents 116, the table 132 may be updated to include (A) a “referrer agent ID” entry 134 indicating the referrer agent 116 from which the “reference usage” message 120 was received, (B) a “reference ID” entry 136 indicating a particular reference 102 that is included within an item of referring content 104, and (C) a “referenced content ID” entry 138 indicating the item of referenced content 106 to which the particular reference 102 refers. Further, as explained in more detail below, in some implementations (e.g., where one or more referrer agents 116 “pull” data concerning updates to items of referenced content 106 from the reference manager 114 on demand), the table 132 may also include one or more fields in which “update data” entries 140 for respective reference IDs 136 can be made.

Referring again to FIG. 1A, the reference manager 114 may additionally receive “reference update” messages 122 from the reference agent 118 that indicate updates to particular items of referenced content 106. Upon receipt of respective “reference update” messages 122, the reference manager 114 may determine one or more appropriate annotations to make to the references 102 that refer to such updated items of referenced content 106. In some implementations, such annotations may be stored as “update data” entries 140 in the table 132 (shown in FIG. 1E). The update data 140 for a particular reference ID 136 may subsequently be requested, on demand, by a referrer agent 116, e.g., at the time an item of referring content 104 that includes an active reference 102 is accessed or is to be displayed, and, in response to such a request, the reference manager 114 may return an “update data” message 124 to the requesting referrer agent 116 including the update data 140 for the indicated reference ID 136. In other implementations, the reference manager 114 may, e.g., based on the referrer agent IDs 134, automatically send “update data” messages 124 indicating the determined update data 140 to the respective referrer agents 116 at the time such update data 140 is first determined. After receiving an “update data” message 124, a referrer agent 116 may cause corresponding annotation(s) 112 to be included within an appropriate item of referring content 104 at the location of the active reference 102 to which such annotation(s) 112 apply. In some implementations, the “update data” messages 124 (sent from the reference manager 114 to the referrer agent(s) 116) may include, along with the update data 140, the reference IDs 136 of the references 102 to which the annotation(s) 112 are to be applied. In other implementations, the “update data” messages 124 may include the referenced content IDs 138 (e.g., URLs) of the items of referenced content 106 to which the update data 140 relates, and the referrer agent(s) 116 may use that information to determine the appropriate location for one or more annotations 112. In some implementations, the referrer agent(s) 116 may maintain one or more tables (not illustrated) that enable them to identify items of referring content 104 and/or locations within such items at which annotation(s) 112 are to be included based on the particular information (e.g., reference IDs 136 and/or referenced content IDs 138) that is included in the “update data” messages 124.

In some implementations, the “reference update” messages 122 may include both updated versions of items of referenced content 106 and versions of the items of referenced content 106 before the updates occurred. In such implementations, the reference manager 114 may compare the two versions and generate the update data 140 to store in the table 132 and/or send to one or more referrer agents 116. In some implementations, such update data 140 may further indicate the time and/or date that the item of referenced content 106 was updated. In some implementations, the update data 140 may further include historical data of previously implemented updates to items of referenced content 106, so as to enable such historical data to be further reflected in the annotations 112 presented within the item of referring content 104, either immediately or in response to user input, as explained above.

In other implementations, the reference agent(s) 118 may compare updated versions of items of referenced content 106 with versions of the items of referenced content 106 before the updates occurred, to generate the update data 140. The reference agent(s) 118 may then send such generated update data 140 to the reference manager 114 for processing, e.g., storing it in the table 132 and/or sending it to one or more referrer agents 116.

Examples of update data 140 that may be determined (e.g., by the reference manager 114 and/or the reference agent(s) 118) are (A) a percentage of the item of referenced content 106 that has changed, (B) a particular status change the item of referenced content 106 has undergone, (C) the identity of one or more sections of the item of referenced content 106 that have been modified, (D) the identity of one or more sections of the item of referenced content 106 that have been removed, and (E) the date and/or time the item of referenced content 106 was updated.

As further shown in FIG. 1A, in some implementations, the reference manager 114 and/or the referrer agent 116 may send messages 126 to the reference agent 118 to inform the reference agent 118 that particular items of referenced content 106 correspond to “active” references 102 within the system 100, e.g., by having their referenced content IDs 138 registered in the table 132 (shown in FIG. 1E). Based on such messages, the reference agent 118 may send “reference update” messages 122 to the reference manager 114 for the particular items of referenced content 106 that were indicated (by the messages 126) as corresponding to active references 102. Such a feature may be beneficial, for example, in implementations in which a repository includes a large number of items of content to which references 102 could potentially refer (e.g., Wikipedia), such that the reference agent 118 need not send “reference update” messages 122 to the reference manager 114 for those items of content that do not correspond to active references 102.

As illustrated by arrow 128 in FIG. 1A, the referrer agent 116 may be configured to interact with items of referring content 104, e.g., to determine references 102 that are to be registered with the reference manager 114 and/or “tag” such references 102 as active, and/or to introduce annotations 112 to the references 102 that have been so registered and/or tagged. In addition, as illustrated by arrow 130 in FIG. 1A, the reference agent 118 may be configured to interact with the referenced content 106, e.g., to determine updates to items of the referenced content 106 that are communicated to the reference manager 114 via the “reference update” messages 122.

The referrer agent 116 may take on any of numerous forms, depending on the nature of the application(s) that is/are responsible for allowing users to edit and/or access the referring content 104. In some implementations, the referrer agent 116 may be a plug-in, add-in, extension, etc., to an application (e.g., Confluence, Outlook, Word, etc.) that is responsible for allowing users to interact with the referring content 104. In other implementations, the referrer agent 116 may be separate from the application that is responsible for allowing users to interact with the referring content 104, and may, for example, be an application or service that interacts with such an application via one or more application programming interface (API) commands, or otherwise. For example, in some implementations, users may interact with the referring content 104 (e.g., a Slackbot message) via Slack, and the referrer agent 116 may be a Slack application.

The reference agent 118 may likewise take on any of numerous forms, depending on the nature of the application(s) that are responsible for creating and/or maintaining the referenced content 106. In some implementations, the reference agent 118 may be a plug-in, add-in, extension, etc., to an application (e.g., a Confluence page plug-in, a Wikipedia extension, etc.) that is responsible for allowing users to interact with the referenced content 106. In other implementations, the reference agent 118 may be separate from the application that is responsible for allowing users to interact with the referenced content, and may, for example, be an application or service that interacts with such an application via one or more application programming interface (API) commands, or otherwise. For example, in some implementations, the reference agent 118 may be an additional service of a file sharing system, such as the ShareFile® system offered by Citrix Systems, Inc., of Fort Lauderdale, Fla. In some implementations, the reference agent 118 may be an application or service that monitors the application that manages items of referenced content 106 for updates, and notifies the reference manager 114 when such updates are detected. For example, as described above, the reference manager 114 and/or the referrer agent may inform the reference agent 118 that particular items of referenced content 106 correspond to “active” references 102 within the system 100. In some implementations, such messages 126 may specify particular items of referenced content 106 (e.g., particular Wikipedia pages) that the reference agent 118 is to monitor for updates.

Additional details and example implementations of embodiments of the present disclosure are set forth below in Section E, following a description of example systems and network environments in which such embodiments may be deployed.

### B. Network Environment

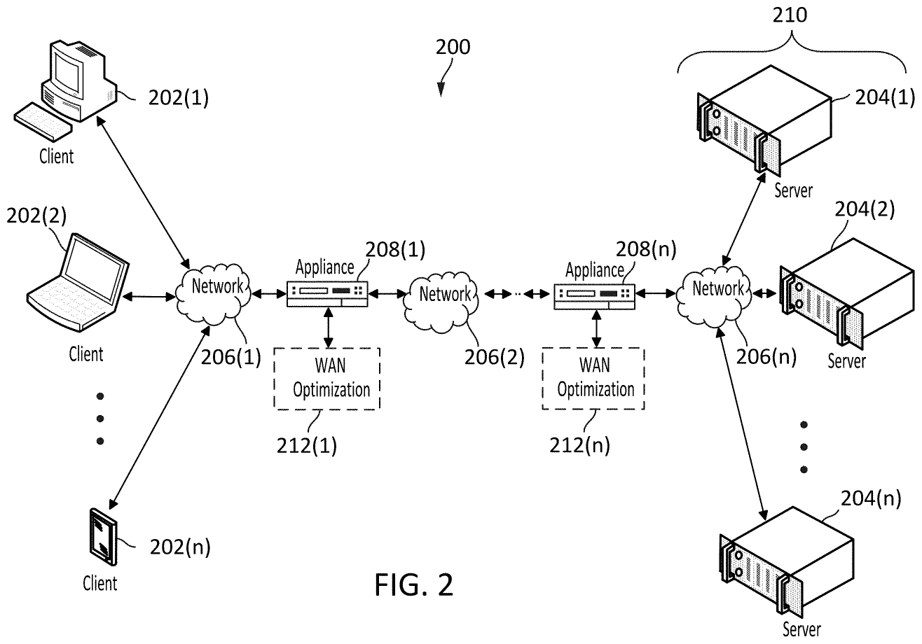

Referring to FIG. 2, an illustrative network environment 200 is depicted. As shown, the network environment 200 may include one or more clients 202(1)-202(n) (also generally referred to as local machine(s) 202 or client(s) 202) in communication with one or more servers 204(1)-204(n) (also generally referred to as remote machine(s) 204 or server(s) 204) via one or more networks 206(1)-206(n) (generally referred to as network(s) 206). In some embodiments, a client 202 may communicate with a server 204 via one or more appliances 208(1)-208(n) (generally referred to as appliance(s) 208 or gateway(s) 208). In some embodiments, a client 202 may have the capacity to function as both a client node seeking access to resources provided by a server 204 and as a server 204 providing access to hosted resources for other clients 202.

Although the embodiment shown in FIG. 2 shows one or more networks 206 between the clients 202 and the servers 204, in other embodiments, the clients 202 and the servers 204 may be on the same network 206. When multiple networks 206 are employed, the various networks 206 may be the same type of network or different types of networks. For example, in some embodiments, the networks 206(1) and 206(n) may be private networks such as local area network (LANs) or company Intranets, while the network 206(2) may be a public network, such as a metropolitan area network (MAN), wide area network (WAN), or the Internet. In other embodiments, one or both of the network 206(1) and the network 206(n), as well as the network 206(2), may be public networks. In yet other embodiments, all three of the network 206(1), the network 206(2) and the network 206(n) may be private networks. The networks 206 may employ one or more types of physical networks and/or network topologies, such as wired and/or wireless networks, and may employ one or more communication transport protocols, such as transmission control protocol (TCP), internet protocol (IP), user datagram protocol (UDP) or other similar protocols. In some embodiments, the network(s) 206 may include one or more mobile telephone networks that use various protocols to communicate among mobile devices. In some embodiments, the network(s) 206 may include one or more wireless local-area networks (WLANs). For short range communications within a WLAN, clients 202 may communicate using 802.11, Bluetooth, and/or Near Field Communication (NFC).

As shown in FIG. 2, one or more appliances 208 may be located at various points or in various communication paths of the network environment 200. For example, the appliance 208(1) may be deployed between the network 206(1) and the network 206(2), and the appliance 208(n) may be deployed between the network 206(2) and the network 206(n). In some embodiments, the appliances 208 may communicate with one another and work in conjunction to, for example, accelerate network traffic between the clients 202 and the servers 204. In some embodiments, appliances 208 may act as a gateway between two or more networks. In other embodiments, one or more of the appliances 208 may instead be implemented in conjunction with or as part of a single one of the clients 202 or servers 204 to allow such device to connect directly to one of the networks 206. In some embodiments, one of more appliances 208 may operate as an application delivery controller (ADC) to provide one or more of the clients 202 with access to business applications and other data deployed in a datacenter, the cloud, or delivered as Software as a Service (SaaS) across a range of client devices, and/or provide other functionality such as load balancing, etc. In some embodiments, one or more of the appliances 208 may be implemented as network devices sold by Citrix Systems, Inc., of Fort Lauderdale, Fla., such as Citrix Gateway™ or Citrix ADC™.

A server 204 may be any server type such as, for example: a file server; an application server; a web server; a proxy server; an appliance; a network appliance; a gateway; an application gateway; a gateway server; a virtualization server; a deployment server; a Secure Sockets Layer Virtual Private Network (SSL VPN) server; a firewall; a web server; a server executing an active directory; a cloud server; or a server executing an application acceleration program that provides firewall functionality, application functionality, or load balancing functionality.

A server 204 may execute, operate or otherwise provide an application that may be any one of the following: software; a program; executable instructions; a virtual machine; a hypervisor; a web browser; a web-based client; a client-server application; a thin-client computing client; an ActiveX control; a Java applet; software related to voice over internet protocol (VoIP) communications like a soft IP telephone; an application for streaming video and/or audio; an application for facilitating real-time-data communications; a HTTP client; a FTP client; an Oscar client; a Telnet client; or any other set of executable instructions.

In some embodiments, a server 204 may execute a remote presentation services program or other program that uses a thin-client or a remote-display protocol to capture display output generated by an application executing on a server 204 and transmit the application display output to a client device 202.

In yet other embodiments, a server 204 may execute a virtual machine providing, to a user of a client 202, access to a computing environment. The client 202 may be a virtual machine. The virtual machine may be managed by, for example, a hypervisor, a virtual machine manager (VMM), or any other hardware virtualization technique within the server 204.

As shown in FIG. 2, in some embodiments, groups of the servers 204 may operate as one or more server farms 210. The servers 204 of such server farms 210 may be logically grouped, and may either be geographically co-located (e.g., on premises) or geographically dispersed (e.g., cloud based) from the clients 202 and/or other servers 204. In some embodiments, two or more server farms 210 may communicate with one another, e.g., via respective appliances 208 connected to the network 206(2), to allow multiple server-based processes to interact with one another.

As also shown in FIG. 2, in some embodiments, one or more of the appliances 208 may include, be replaced by, or be in communication with, one or more additional appliances, such as WAN optimization appliances 212(1)-212(n), referred to generally as WAN optimization appliance(s) 212. For example, WAN optimization appliances 212 may accelerate, cache, compress or otherwise optimize or improve performance, operation, flow control, or quality of service of network traffic, such as traffic to and/or from a WAN connection, such as optimizing Wide Area File Services (WAFS), accelerating Server Message Block (SMB) or Common Internet File System (CIFS). In some embodiments, one or more of the appliances 212 may be a performance enhancing proxy or a WAN optimization controller.

In some embodiments, one or more of the appliances 208, 212 may be implemented as products sold by Citrix Systems, Inc., of Fort Lauderdale, Fla., such as Citrix SD-WAN™ or Citrix Cloud™. For example, in some implementations, one or more of the appliances 208, 212 may be cloud connectors that enable communications to be exchanged between resources within a cloud computing environment and resources outside such an environment, e.g., resources hosted within a data center of+ an organization.

### C. Computing Environment

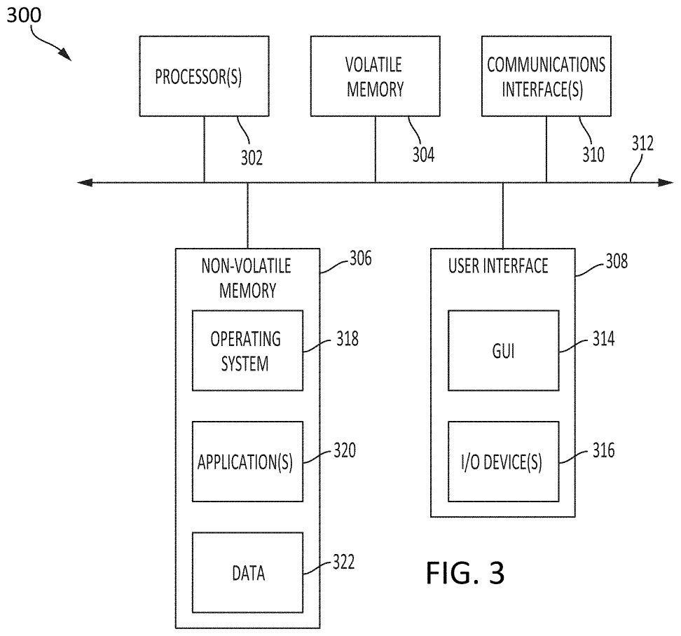

FIG. 3 illustrates an example of a computing system 300 that may be used to implement one or more of the respective components (e.g., the clients 202, the servers 204, the appliances 208, 212) within the network environment 200 shown in FIG. 2. As shown in FIG. 3, the computing system 300 may include one or more processors 302, volatile memory 304 (e.g., RAM), non-volatile memory 306 (e.g., one or more hard disk drives (HDDs) or other magnetic or optical storage media, one or more solid state drives (SSDs) such as a flash drive or other solid state storage media, one or more hybrid magnetic and solid state drives, and/or one or more virtual storage volumes, such as a cloud storage, or a combination of such physical storage volumes and virtual storage volumes or arrays thereof), a user interface (UI) 308, one or more communications interfaces 310, and a communication bus 312. The user interface 308 may include a graphical user interface (GUI) 314 (e.g., a touchscreen, a display, etc.) and one or more input/output (I/O) devices 316 (e.g., a mouse, a keyboard, etc.). The non-volatile memory 306 may store an operating system 318, one or more applications 320, and data 322 such that, for example, computer instructions of the operating system 318 and/or applications 320 are executed by the processor(s) 302 out of the volatile memory 304. Data may be entered using an input device of the GUI 314 or received from I/O device(s) 316. Various elements of the computing system 300 may communicate via communication the bus 312. The computing system 300 as shown in FIG. 3 is shown merely as an example, as the clients 202, servers 204 and/or appliances 208 and 212 may be implemented by any computing or processing environment and with any type of machine or set of machines that may have suitable hardware and/or software capable of operating as described herein.

The processor(s) 302 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs), microprocessors, digital signal processors, microcontrollers, field programmable gate arrays (FPGAs), programmable logic arrays (PLAs), multi-core processors, or general-purpose computers with associated memory. The “processor” may be analog, digital or mixed-signal. In some embodiments, the “processor” may be one or more physical processors or one or more “virtual” (e.g., remotely located or “cloud”) processors.

The communications interfaces 310 may include one or more interfaces to enable the computing system 300 to access a computer network such as a Local Area Network (LAN), a Wide Area Network (WAN), a Personal Area Network (PAN), or the Internet through a variety of wired and/or wireless connections, including cellular connections.

As noted above, in some embodiments, one or more computing systems 300 may execute an application on behalf of a user of a client computing device (e.g., a client 202 shown in FIG. 2), may execute a virtual machine, which provides an execution session within which applications execute on behalf of a user or a client computing device (e.g., a client 202 shown in FIG. 2), such as a hosted desktop session, may execute a terminal services session to provide a hosted desktop environment, or may provide access to a computing environment including one or more of: one or more applications, one or more desktop applications, and one or more desktop sessions in which one or more applications may execute.

### D. Systems and Methods for Delivering Shared Resources Using a Cloud Computing Environment

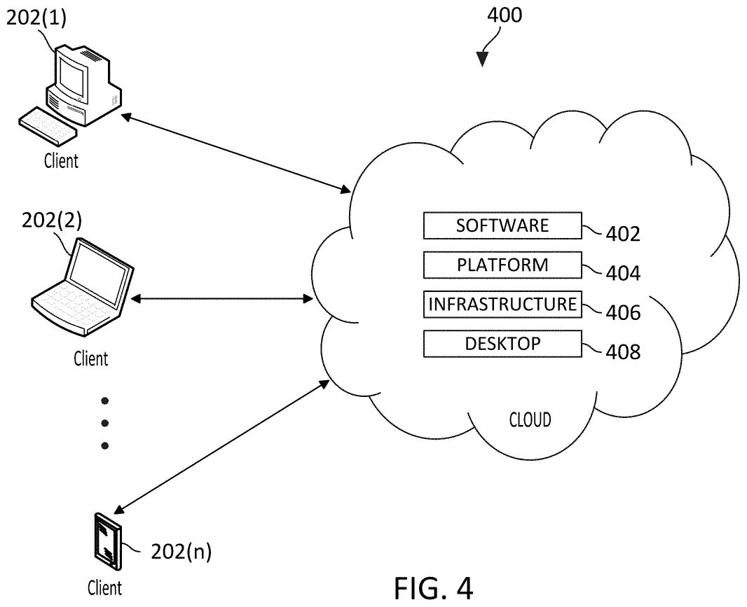

Referring to FIG. 4, a cloud computing environment 400 is depicted, which may also be referred to as a cloud environment, cloud computing or cloud network. The cloud computing environment 400 can provide the delivery of shared computing services and/or resources to multiple users or tenants. For example, the shared resources and services can include, but are not limited to, networks, network bandwidth, servers, processing, memory, storage, applications, virtual machines, databases, software, hardware, analytics, and intelligence.

In the cloud computing environment 400, one or more clients 202 (such as those described in connection with FIG. 2) are in communication with a cloud network 404. The cloud network 404 may include back-end platforms, e.g., servers, storage, server farms and/or data centers. The clients 202 may correspond to a single organization/tenant or multiple organizations/tenants. More particularly, in one example implementation, the cloud computing environment 400 may provide a private cloud serving a single organization (e.g., enterprise cloud). In another example, the cloud computing environment 400 may provide a community or public cloud serving multiple organizations/tenants.

In some embodiments, a gateway appliance(s) or service may be utilized to provide access to cloud computing resources and virtual sessions. By way of example, Citrix Gateway, provided by Citrix Systems, Inc., may be deployed on-premises or on public clouds to provide users with secure access and single sign-on to virtual, SaaS and web applications. Furthermore, to protect users from web threats, a gateway such as Citrix Secure Web Gateway may be used. Citrix Secure Web Gateway uses a cloud-based service and a local cache to check for URL reputation and category.

In still further embodiments, the cloud computing environment 400 may provide a hybrid cloud that is a combination of a public cloud and one or more resources located outside such a cloud, such as resources hosted within one or more data centers of an organization. Public clouds may include public servers that are maintained by third parties to the clients 202 or the enterprise/tenant. The servers may be located off-site in remote geographical locations or otherwise. In some implementations, one or more cloud connectors may be used to facilitate the exchange of communications between one more resources within the cloud computing environment 400 and one or more resources outside of such an environment.

The cloud computing environment 400 can provide resource pooling to serve multiple users via clients 202 through a multi-tenant environment or multi-tenant model with different physical and virtual resources dynamically assigned and reassigned responsive to different demands within the respective environment. The multi-tenant environment can include a system or architecture that can provide a single instance of software, an application or a software application to serve multiple users. In some embodiments, the cloud computing environment 400 can provide on-demand self-service to unilaterally provision computing capabilities (e.g., server time, network storage) across a network for multiple clients 202. By way of example, provisioning services may be provided through a system such as Citrix Provisioning Services (Citrix PVS). Citrix PVS is a software-streaming technology that delivers patches, updates, and other configuration information to multiple virtual desktop endpoints through a shared desktop image. The cloud computing environment 400 can provide an elasticity to dynamically scale out or scale in response to different demands from one or more clients 202. In some embodiments, the cloud computing environment 400 may include or provide monitoring services to monitor, control and/or generate reports corresponding to the provided shared services and resources.

In some embodiments, the cloud computing environment 400 may provide cloud-based delivery of different types of cloud computing services, such as Software as a service (SaaS) 402, Platform as a Service (PaaS) 404, Infrastructure as a Service (IaaS) 406, and Desktop as a Service (DaaS) 408, for example. IaaS may refer to a user renting the use of infrastructure resources that are needed during a specified time period. IaaS providers may offer storage, networking, servers or virtualization resources from large pools, allowing the users to quickly scale up by accessing more resources as needed. Examples of IaaS include AMAZON WEB SERVICES provided by Amazon.com, Inc., of Seattle, Wash., RACKSPACE CLOUD provided by Rackspace US, Inc., of San Antonio, Tex., Google Compute Engine provided by Google Inc. of Mountain View, Calif., or RIGHTSCALE provided by RightScale, Inc., of Santa Barbara, Calif.

PaaS providers may offer functionality provided by IaaS, including, e.g., storage, networking, servers or virtualization, as well as additional resources such as, e.g., the operating system, middleware, or runtime resources. Examples of PaaS include WINDOWS AZURE provided by Microsoft Corporation of Redmond, Wash., Google App Engine provided by Google Inc., and HEROKU provided by Heroku, Inc. of San Francisco, Calif.

SaaS providers may offer the resources that PaaS provides, including storage, networking, servers, virtualization, operating system, middleware, or runtime resources. In some embodiments, SaaS providers may offer additional resources including, e.g., data and application resources. Examples of SaaS include GOOGLE APPS provided by Google Inc., SALESFORCE provided by Salesforce.com Inc. of San Francisco, Calif., or OFFICE 365 provided by Microsoft Corporation. Examples of SaaS may also include data storage providers, e.g. Citrix ShareFile from Citrix Systems, DROPBOX provided by Dropbox, Inc. of San Francisco, Calif., Microsoft SKYDRIVE provided by Microsoft Corporation, Google Drive provided by Google Inc., or Apple ICLOUD provided by Apple Inc. of Cupertino, Calif.

Similar to SaaS, DaaS (which is also known as hosted desktop services) is a form of virtual desktop infrastructure (VDI) in which virtual desktop sessions are typically delivered as a cloud service along with the apps used on the virtual desktop. Citrix Cloud from Citrix Systems is one example of a DaaS delivery platform. DaaS delivery platforms may be hosted on a public cloud computing infrastructure, such as AZURE CLOUD from Microsoft Corporation of Redmond, Wash., or AMAZON WEB SERVICES provided by Amazon.com, Inc., of Seattle, Wash., for example. In the case of Citrix Cloud, Citrix Workspace app may be used as a single-entry point for bringing apps, files and desktops together (whether on-premises or in the cloud) to deliver a unified experience.

### E. Detailed Description of Example Embodiments of Content Reference Management System

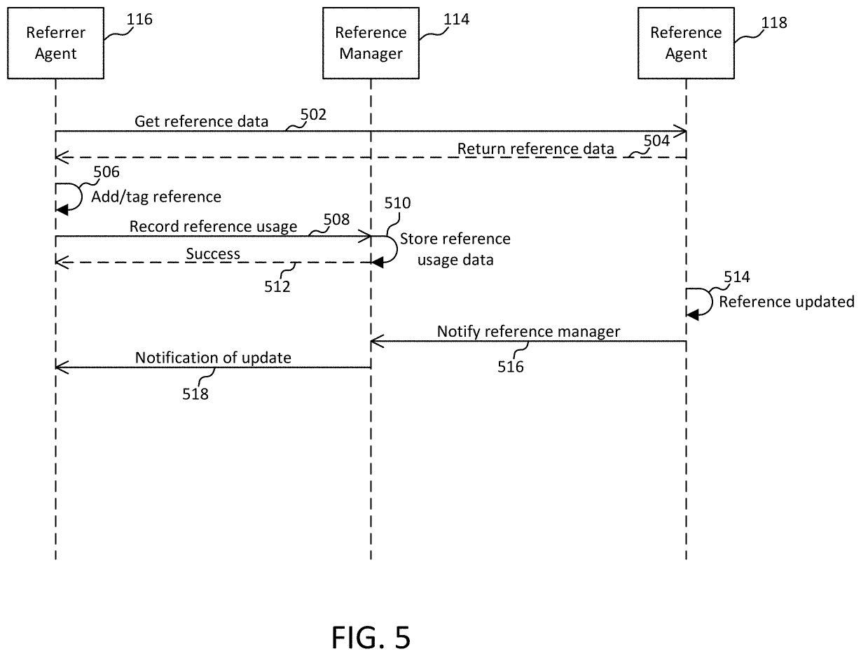

As discussed above in Section A, a content reference management system 100 may include three components (including a reference manager 114, a referrer agent 116, and a reference agent 118) to facilitate the management of content references as described herein. FIG. 5 is a sequence diagram illustrating an example workflow involving those three components. As Section A notes, the referrer agent 116 and the reference agent 118 may operate as components of, or in conjunction with, one or more applications that allow users to interact with referring content 104 and/or the referenced content 106. For example, the referrer agent 116 may operate as a component of, or in conjunction with, applications such as Confluence, Slack, Outlook, Word, a microapp (i.e., a small application that is configured to invoke one or more specific functions of a larger application, such as by accessing APIs of the larger application) or any other application in which a reference 102 to an item of referenced content 106 can be introduced. The reference agent 118 may, for example, operate as a component of, or in conjunction with, applications such as Confluence, ShareFile®, Wikipedia, Westlaw, iManage, or any other application that manages or includes content to which one or more references 102 can potentially refer. Although not illustrated in FIG. 5, it should be appreciated that certain of the indicated operations in the sequence flow, e.g., steps 502 and 504 involving the determining of a referenced content ID 138 for a reference 102 to an item of referenced content 106 that is to be registered with the reference manager 114 (as described below), may instead be performed using the underlying applications themselves, or otherwise, depending on the implementation.

As shown in FIG. 5, the referrer agent 116 and/or the application that manages the referring content 104 may, per the steps 502 and 504, obtain reference data (e.g., a referenced content ID 138) for a reference 102 to an item of referenced content 106 from the reference agent 118 and/or the application that manages the referenced content 106. Referenced content IDs 138 may take on any of numerous forms and may be obtained in an of a number of ways, depending on the implementation. In some implementations, for example, the referenced content IDs 138 may be links, e.g., uniform resource locator (URL) links, to network resources (e.g., Confluence pages, Wikipedia pages, folders of a file sharing system, etc.) at which the items of referenced content 106 are located, or links to files maintained by a document management system, such as iManage. In other implementations, the referenced content IDs 138 may be simply text strings that identify particular items of referenced content 106 that the reference agent 118 can monitor for updates. In still other implementations, the referenced content IDs 138 may specify external libraries or packages on which items of referring content 104 (e.g., software code) have dependency relationships, or may specify a particular piece of code on which another application relies, such as an API that is used by a microapp.

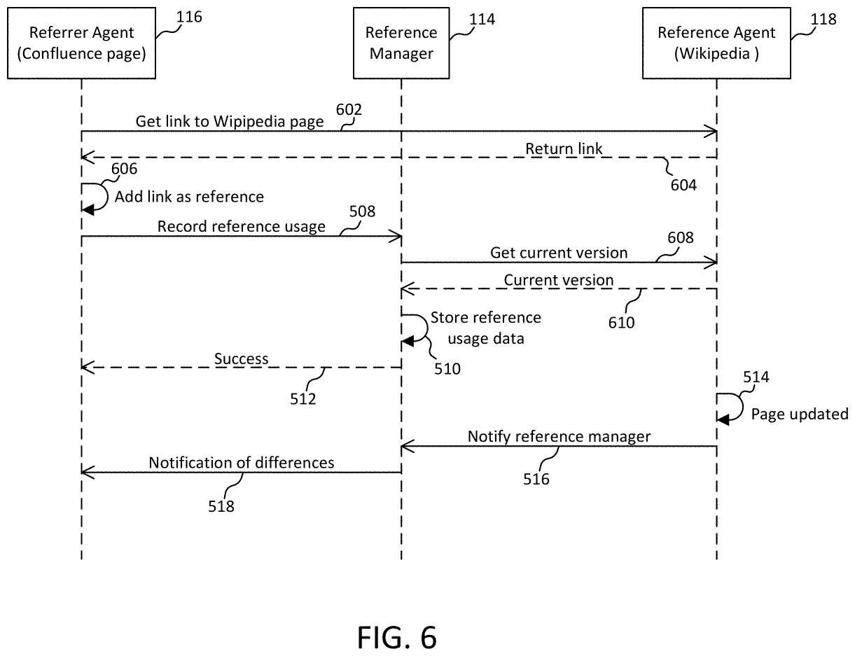

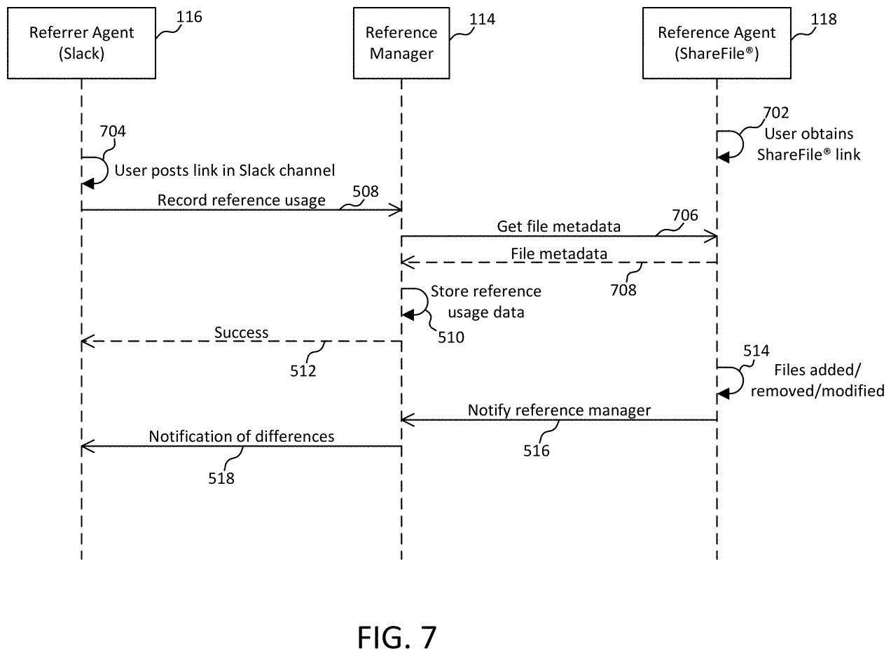

In some implementations, the reference data (e.g., referenced content IDs 138) obtained at the steps 502 and 504 may be copied, e.g., in response to user input, from an application presenting an item of referenced content 106, and may then be pasted into an item of referring content 104. For example, a user may operate a browser to access a Wikipedia page, and may then copy the URL for that page from the browser search bar and paste it at an appropriate location within an item of referring content 104, e.g., a page of a Confluence application. FIG. 6 (described below) is a sequence diagram illustrating such a scenario. As another example, a user may obtain a link to a folder on a file sharing system, e.g., ShareFile®, or a document management system, e.g., iManage, and either the same user or a different user (e.g., a user to whom the link is emailed) may copy such a link into a Slack channel, or some other messaging application, such as Outlook. FIG. 7 (described below) is a sequence diagram illustrating that example scenario.

As FIG. 5 illustrates, once reference data (e.g., a referenced content ID 138) is obtained (per the step 504), the referrer agent 116 may take one or more steps 506 to indicate a new “active” reference 102 (i.e., a reference 102 for which update data 140 is to be received) within an item of referring content 104. In some implementations, the fact that a referenced content ID 138 having a particular format has been copied or otherwise entered into an item of referring content 104 may be recognized by the referrer agent 116 as an indication that a new reference 102 is active. For example, in some implementations, the reference manager 114 may recognize base URLs for Wikipedia pages and may treat new data copied to the item of referring content 104 that includes such a base URL as an active reference 102. The referrer agent 116 may, for example, be configured to recognize, based on the presence of base URLs or otherwise, referenced content IDs 138 that originate from one or more particular applications that are configured with and/or operate in conjunction with reference agents 118, and may detect the existence of a new active reference 102 in response to such referenced content IDs 138 being copied into an item of referring content 104.

In other implementations, the referrer agent 116 may detect that a user has copied or otherwise inserted a referenced content ID 138 into a particular region of an item of referring content 104, e.g., within a portion of a Confluence page that lists one or more references, such as the “references” region 142 of the item of referring content 104 shown in FIG. 1B, and may detect the existence of a new active reference 102 in response to such data being added within the particular region.

In still other implementations, a user may be provided with one or more user interface tools that allow the identification of new active references 102 within an item of referring content 104. For example, in some implementations, a user may highlight or otherwise select a referenced content ID 138 or text of a reference 102 (e.g., the displayed text of a link for a URL or other network path identifier) within an item of referring content 104 and then right-click to reveal one or more menu options relating to the management of references 102. For example, after selecting a referenced content ID 138 or the text of a reference 102 within an item of referring content 104, the user may select an option to “register reference to receive updates,” or the like. In some implementations, the user may further be presented with an option to indicate and/or confirm the referenced content ID 138 (e.g., a URL, network path, document number, publication volume and page number(s), etc.) that the system 100 is to use to identify the new active reference 102. For example, in some implementations, a user may initially select text describing an item of referenced content 106 (e.g., the name of a technical standard document) and request, via a user interface, that the selected text be registered as an active reference 102. In some implementations, the user may then be prompted to enter, select, and/or confirm the referenced content ID 138 that the system is to use to identify the particular item of referenced content 106, such as the URL to a page of an organization from which an official version of the document can be accessed.

In some implementations, in response to determining that a new active reference 102 is present within an item of referring content 104, using any of the foregoing techniques or otherwise, the referrer agent 116 may “tag” the reference 102 within the item of referring content 104, thus allowing one or more annotations to be appended to the reference 102 in the event that the reference manager 114 is notified of updates to the same. In some implementations, for example, a reference ID 136 may be inserted (e.g., as metadata) within the item of referring content 104 at the location of the reference 102. Such an “inserted” reference ID 136 may either be generated by the referrer agent 116 or obtained from the reference manager 114. In other implementations, e.g., where the referenced content IDs 138 themselves uniquely identify particular items of referenced content 106 (e.g., as is generally the case with URLs), the referenced content IDs 138 may themselves be used as tags, thus obviating the need to add additional metadata into the item of referring content 104 for tagging purposes.

As shown in FIG. 5, at a step 508, the referrer agent 116 may send a message to the reference manager 114 instructing the reference manager 114 to register the new active reference 102 within the item of referring content 104, e.g., by adding a new row to the table 132 (shown in FIG. 1E). In some implementations, such a registration request may include a reference ID 136 for the active reference 102 in addition to the referenced content ID 138 for the to-be-registered reference 102. In other implementations, the registration request may not include a separate reference ID 136, and may instead use the referenced content ID 138 to identify the reference 102 to the system 100. In such implementations, the referrer agent 116 may, for example, rely upon referenced content IDs 138 that are included subsequently-received notifications (described below in connection with a step 518) about updates to references 102 to determine locations of those reference 102 within items of referring content 104. In some implementations, the referrer agent(s) 116 may additionally update one or more local records, in one or more tables or otherwise, sufficient to allow them to determine the references 102 for which annotations 112 are to be presented in response to the “update data” messages 124 that they subsequently receive from the reference manager 114. For example, in some implementations, the referrer agent(s) 116 may maintain one or more tables correlating reference IDs 136 and/or referenced content IDs 138 with particular items of referring content 104.

At a step 510, the reference manager 114 may store data indicative of the newly added reference in one or more storage mediums, e.g., by adding a new row to the table 132 (shown in FIG. 1E).

At a step 512, after the reference manager 114 has registered the new reference 102, e.g., by adding a new row to the table 132, the reference manager 114 may send a message to the referrer agent 116 that sent it the request to register the new reference 102 indicating that the new reference 102 has been successfully registered.

At a step 514, the reference agent 118 may determine that an item of referenced content 106 to which a reference 102 refers has been updated. As discussed above, in some implementations, the reference agent 118 may determine that items of referenced content 106 have been updated in response to user inputs, e.g., via user interface elements such as the button 108 shown in FIG. 1C. In other implementations, as also discussed above, the reference agent 118 may additionally or alternatively automatically detect updates to one or more items of referenced content 106. As noted, in some implementations, the reference manager 114 and/or the referrer agent 116 may have previously apprised the reference agent 118 of the referenced content IDs 138 of one or more items of referenced content 106 that the reference agent 118 is to monitor for updates. In other implementations, the reference agent 118 may detect updates to the items of content for the application(s) it manages, without first being apprised of particular items of referenced content 106 that have been registered with the system 100.

At a step 516, the reference agent 118 may send a message to the reference manager 114 apprising it of one or more updates detected at the step 514. In some implementations, such messages may identify the updated items using referenced content IDs 138. In other implementations, the reference agent 118 may identify the updated items using reference IDs 136, e.g., in implementations in which the reference agent 118 is apprised (e.g., via messages 126 shown in FIG. 1A) of items of referenced content 106 that are registered with the system 100, and where reference IDs 136 are included in such messages 126. In such implementations, the reference agent 118 may, for example, maintain a table that correlates reference IDs 136 with referenced content IDs 138 for the references 102 that are indicated as being active.

As noted above, in some implementations, the message(s) sent at the step 516 may include both an updated version of the item of referenced content 106 and a version of the item of referenced content 106 prior to the update, so as to allow the reference manager 114 to compare the two versions and generate the update data 140 to include in the table 132 and/or send immediately to one or more referrer agents 116. An example of such an implementation is described below in connection with FIG. 7. In other implementations, the reference manager 114 may retrieve and store a current version of a newly-registered item of referenced content 106 (e.g., a Wikipedia page) when the reference 102 to that item is first registered with system 100 (e.g., between the steps 508 and 514). In such implementations, the reference manager 114 may compare that prior version with an updated version obtained in connection with the step 516, and may determine the update data 140 based on such comparison. An example of such an implementation is described below in connection with FIG. 6. In still other implementations, the reference agent 118 may compare the updated version with a prior version to generate the update data 140. In such implementations, the update data 140 may be included in the message(s) the reference agent 118 sends to the reference manager 114 per the step 516.

Further, as noted previously, in some implementations, the time and/or date of updates to items of referenced content 106 may be indicated in the update data 140. Such time and/or date data may either be determined by the reference agent 118 and communicated to the reference manager 114 per the step 516 or may be determined by the reference manager 114 in response to receiving the message(s) per the step 516.

At a step 518, the reference manager 114 may send one or more messages to the referrer agent(s) 116 notifying the referrer agent(s) 116 about the detected update to the item of referenced content 106. As noted above, such messages may include the update data 140. In response to receiving the update data 140, the referrer agent 116 may cause a reference 102 within an item of referring content 104 to include an annotation 112, as described above in connection with FIG. 1D. As explained previously, in some implementations, the notification per the step 518 may be retrieved, on demand, by a referrer agent 116 and/or an application that manages an item of referring content 104 that includes an active reference 102. In other implementations, as also explained above, the update data 140 may be communicated immediately to one or more referrer agents 116 after it is determined. In the latter case, the referrer agent(s) 116 may, for example, store the update data 140 in one or more tables, e.g., the table 132 shown in FIG. 1E, for subsequent access by the referrer agents 116 and/or applications that manage items of referring content 104 that include active references 102.

FIGS. 6 and 7 are sequence diagrams illustrating respective example scenarios in which aspects of the basic implementation described in connection with FIG. 5 may be employed. In particular, FIG. 6 shows a sequence diagram for a scenario where the referrer agent 116 includes a plug-in or add-in for a Confluence application and the reference agent 118 includes an application or service that interfaces with Wikipedia, and in which a link to a Wikipedia page is added as a reference 102 to a Confluence page. FIG. 7, on the other hand, shows a sequence diagram for a scenario where the referrer agent 116 includes a Slack application and the reference agent 118 includes a ShareFile® service, and in which a link to one or more files on ShareFile® is added as a reference 102 to a Slack channel.

Referring first to FIG. 6, at steps 602, 604 and 606, a link to a Wikipedia page may be obtained and added to a page of a Confluence application. As one illustrative example, a user may (A) navigate to a Wikipedia page, (B) copy a URL from a browser search bar, and (C) paste the copied URL into the “references” region 142 (see FIGS. 1B and 1D) of a Confluence application and/or into an address field of a hyperlink that provides a textual description of the Wikipedia page. The referrer agent 116 may then request (per the step 508—as described above), that the new reference 102 (to the Wikipedia) page be recorded with the reference manager 114 as described above in connection with FIG. 5.

Per steps 608 and 610, the reference manager 114 may retrieve a copy of the hypertext markup language (HTML) code for the referenced Wikipedia page from a Wikipedia server and, per the step 510, may store that code, together with other data indicative of the newly added reference, in one or more storage mediums, e.g., by adding a new row to the table 132 (shown in FIG. 1E). The stored code for the Wikipedia page may, for example, be used= to identify changes in a subsequently obtained copy of the HTML code for the page. The remainder of the sequence diagram of FIG. 6 may essentially follow the same flow as the sequence diagram described in connection with FIG. 5. In some implementations, when an update to the Wikipedia page is identified (per the step 514), the message sent to the reference manager 114 (per the step 516) may, in addition to indicating that an update has occurred, include the updated version of the HTML code for the referenced Wikipedia page, thus allowing the reference manager 114 to identify salient differences between it and the previously retrieved version, and to communicate a summary of such differences to the referrer agent 116 (per the step 518), e.g., as the update data 140 described above.

Referring next to FIG. 7, per steps 702 and 704, a link to one or more files in a ShareFile® folder may be obtained and such a link may be posted (as a reference 102) in Slack channel. After the referrer agent 116 has requested (per the step 508—as described above) that the newly-added reference 102 be recorded with the reference manager 114, the reference manager 114 may (per steps 706 and 708) retrieve metadata from ShareFile® describing the files that can be accessed using the link, and (per the step 510) may store that metadata, together with other data indicative of the newly added reference, in one or more storage mediums, e.g., by adding a new row to the table 132 (shown in FIG. 1E). In some implementations, for example, the retrieved metadata may identify the names of the accessible files as well as hashes of their contents. Such stored metadata may, for example, be used to determine and understand differences between the original contents of the linked folder and the contents after an update is detected (per the step 514).

As was the case with the sequence diagram of FIG. 6, the remainder of the sequence diagram of FIG. 7 may essentially follow the same flow as the sequence diagram described in connection with FIG. 5. In some implementations, when an update to the contents of the linked ShareFile® folder is identified (per the step 514), the message sent to the reference manager 114 (per the step 516) may, in addition to indicating that an update has occurred, include metadata describing the contents of the referenced folder following the detected update, thus allowing the reference manager 114 to identify salient differences between the contents of the folder before and after the update, and to communicate a summary of such differences to the referrer agent 116 (per the step 518), e.g., as the update data 140 described above.

As noted above, in some implementations, the reference agent 118 may cause a user interface element (e.g., a button) to be presented within an application that manages items of referenced content 106, so as to permit a user to indicate particular updates that are to result in notifications being sent to referrer agents 116 (per the step 518). In the case of ShareFile®, for instance, the creator or custodian of a link may be provided with an option to “notify referrers,” e.g., by clicking a button, if and when that individual determines that others referring to the link (e.g., in a Slack channel, email message, or otherwise) ought to be notified about the update.

### F. Example Implementations of Methods, Systems, and Computer-Readable Media in Accordance with the Present Disclosure

The following paragraphs (M1) through (M11) describe examples of methods that may be implemented in accordance with the present disclosure.

(M1) A method may be performed that involves storing, by a computing system, data indicating that first content accessible by an endpoint device includes a reference to second content of a first application hosted on a remote computing device; receiving, by the computing system, an indication of an update to the second content; and sending, by the computing system, a notification to cause the endpoint device to output an indicator of the update to the second content.

(M2) A method may be performed as described in paragraph (M1), and may further involve configuring the notification to cause the endpoint device to output an annotation to a displayed representation of the reference within the first content, the annotation indicative of the update.

(M3) A method may be performed as described in paragraph (M1) or paragraph (M2), wherein the first application may be configured to provide the endpoint device with access to the second content.

(M4) A method may be performed as described in any of paragraphs (M1) through (M3), wherein receiving the indication of the update may include receiving the indication from a first agent of the first application, and sending the notification may include sending the notification to a second agent of a second application that is configured to provide the endpoint device with access to the first content.

(M5) A method may be performed as described in paragraph (M4), and may further involve receiving, by the computing system from the second agent, a request to register use of the reference to the second content by the first content; and storing, by the computing system, the data in response to the request.

(M6) A method may be performed as described in paragraph (M4) or paragraph (M5), wherein the computing system may send the notification to the second agent in response to receiving the indication of the update from the first agent.

(M7) A method may be performed as described in paragraph (M4) or paragraph (M5), wherein the method may further involve storing, by the computing system and based at least in part on the indication of the update received from the first agent, annotation data, and receiving, by the computing system from second agent, a request to receive stored annotation data for the second content, and sending the notification may include sending the stored annotation data to the second agent in response to the request.

(M8) A method may be performed as described in paragraph (M1) or paragraph (M2), wherein the first application may be configured to provide the endpoint device with access to the first content and the second content, wherein receiving the indication of the update may include receiving the indication from a first agent of the first application, and wherein sending the notification may include sending the notification to a second agent of the first application.

(M9) A method may be performed as described in paragraph (M8), and may further involve receiving, by the computing system from the second agent, a request to register use of the reference to the second content by the first content; and storing, by the computing system, the data in response to the request.

(M10) A method may involve sending, by a first computing system to a second computing system, a request to register that first content accessible by an endpoint device includes a reference to second content of an application hosted on a remote computing device; receiving, by the first computing system from the second computing system, a notification of an update to the second content; and causing, by the first computing system and in response to receiving the notification, the endpoint device to output an indicator of the update.

(M11) A method may be performed as described in paragraph (M10), wherein causing the endpoint device to output the indicator may include causing the endpoint device to output an annotation to a displayed representation of the reference within the first content, the annotation indicative of the update.

The following paragraphs (S1) through (S11) describe examples of systems and devices that may be implemented in accordance with the present disclosure.

(S1) A system may comprise at least one processor and at least one computer-readable medium encoded with instructions which, when executed by the at least one processor, cause the system to store data indicating that first content accessible by an endpoint device includes a reference to second content of a first application hosted on a remote computing device, to receive an indication of an update to the second content, and to send a notification to cause the endpoint device to output an indicator of the update to the second content.

(S2) A system may be configured as described in paragraph (S1), wherein the at least one computer-readable medium may be encoded with additional instructions which, when executed by the at least one processor, further cause the system to configure the notification to cause the endpoint device to output an annotation to a displayed representation of the reference within the first content, the annotation indicative of the update.

(S3) A system may be configured as described in paragraph (S1) or paragraph (S2), wherein the first application may be configured to provide the endpoint device with access to the second content.

(S4) A system may be configured as described in any of paragraphs (S1) through (S3), wherein the at least one computer-readable medium may be encoded with additional instructions which, when executed by the at least one processor, further cause the system to receive the indication from a first agent of the first application, and to send the notification to a second agent of a second application that is configured to provide the endpoint device with access to the first content.

(S5) A system may be configured as described in paragraph (S4), wherein the at least one computer-readable medium may be encoded with additional instructions which, when executed by the at least one processor, further cause the system to receive, from the second agent, a request to register use of the reference to the second content by the first content, and to store the data in response to the request.

(S6) A system may be configured as described in paragraph (S4) or paragraph (S5), wherein the at least one computer-readable medium may be encoded with additional instructions which, when executed by the at least one processor, further cause the system to send the notification to the second agent in response to receiving the indication of the update from the first agent.

(S7) A system may be configured as described in paragraph (S4) or paragraph (S5), wherein the at least one computer-readable medium may be encoded with additional instructions which, when executed by the at least one processor, further cause the system to store, based at least in part on the indication of the update received from the first agent, annotation data, to receive, from second agent, a request to receive stored annotation data for the second content, and to send the stored annotation data to the second agent in response to the request.

(S8) A system may be configured as described in paragraph (S1) or paragraph (S2), wherein the first application may be configured to provide the endpoint device with access to the first content and the second content, and the at least one computer-readable medium may be encoded with additional instructions which, when executed by the at least one processor, further cause the system to receive the indication from a first agent of the first application, and to send the notification to a second agent of the first application.

(S9) A system may be configured as described in paragraph (S8), and the at least one computer-readable medium may be encoded with additional instructions which, when executed by the at least one processor, further cause the system to receive, from the second agent, a request to register use of the reference to the second content by the first content, and to store the data in response to the request.

(S10) A first computing system may comprise at least one processor and at least one computer-readable medium encoded with instructions which, when executed by the at least one processor, cause the first computing system to send, to a second computing system, a request to register that first content accessible by an endpoint device includes a reference to second content of an application hosted on a remote computing device, to receive, from the second computing system, a notification of an update to the second content, and to cause the endpoint device to output an indicator of the update in response to receiving the notification.

(S11) A system may be configured as described in paragraph (S10), wherein the at least one computer-readable medium may be encoded with additional instructions which, when executed by the at least one processor, further cause the system to cause the endpoint device to output the indicator at least in part by causing the endpoint device to output an annotation to a displayed representation of the reference within the first content, the annotation indicative of the update.

The following paragraphs (CRM1) through (CRM11) describe examples of computer-readable media that may be implemented in accordance with the present disclosure.

(CRM1) At least one non-transitory, computer-readable medium may be encoded with instructions which, when executed by at least one processor included in a computing system, cause the computing system to store data indicating that first content accessible by an endpoint device includes a reference to second content of a first application hosted on a remote computing device, to receive an indication of an update to the second content, and to send a notification to cause the endpoint device to output an indicator of the update to the second content.

(CRM2) At least one non-transitory, computer-readable medium may be configured as described in paragraph (CRM1), and may be encoded with additional instructions which, when executed by the at least one processor, further cause the computing system to configure the notification to cause the endpoint device to output an annotation to a displayed representation of the reference within the first content, the annotation indicative of the update.

(CRM3) At least one non-transitory, computer-readable medium may be configured as described in paragraph (CRM1) or paragraph (CRM2), wherein the first application may be configured to provide the endpoint device with access to the second content.

(CRM4) At least one non-transitory, computer-readable medium may be configured as described in any of paragraphs (CRM1) through (CRM3), and may be encoded with additional instructions which, when executed by the at least one processor, further cause the computing system to receive the indication from a first agent of the first application, and to send the notification to a second agent of a second application that is configured to provide the endpoint device with access to the first content.

(CRM5) At least one non-transitory, computer-readable medium may be configured as described in paragraph (CRM4), and may be encoded with additional instructions which, when executed by the at least one processor, further cause the computing system to receive, from the second agent, a request to register use of the reference to the second content by the first content, and to store the data in response to the request.

(CRM6) At least one non-transitory, computer-readable medium may be configured as described in paragraph (CRM4) or paragraph (CRM5), and may be encoded with additional instructions which, when executed by the at least one processor, further cause the computing system to send the notification to the second agent in response to receiving the indication of the update from the first agent.

(CRM7) At least one non-transitory, computer-readable medium may be configured as described in paragraph (CRM4) or paragraph (CRM5), and may be encoded with additional instructions which, when executed by the at least one processor, further cause the computing system to store, based at least in part on the indication of the update received from the first agent, annotation data, to receive, from second agent, a request to receive stored annotation data for the second content, and to send the stored annotation data to the second agent in response to the request.

(CRM8) At least one non-transitory, computer-readable medium may be configured as described in paragraph (CRM1) or paragraph (CRM2), wherein the first application may be configured to provide the endpoint device with access to the first content and the second content, and the at least one computer-readable medium may be encoded with additional instructions which, when executed by the at least one processor, further cause the computing system to receive the indication from a first agent of the first application, and to send the notification to a second agent of the first application.

(CRM9) At least one non-transitory, computer-readable medium may be configured as described in paragraph (CRM8), and may be encoded with additional instructions which, when executed by the at least one processor, further cause the computing system to receive, from the second agent, a request to register use of the reference to the second content by the first content, and to store the data in response to the request.

(CRM10) At least one non-transitory, computer-readable medium may be encoded with instructions which, when executed by at least one processor included in a first computing system, cause the first computing system to send, to a second computing system, a request to register that first content accessible by an endpoint device includes a reference to second content of an application hosted on a remote computing device, to receive, from the second computing system, a notification of an update to the second content, and to cause the endpoint device to output an indicator of the update in response to receiving the notification.

(CRM11) At least one non-transitory, computer-readable medium may be configured as described in paragraph (CRM10), and may be encoded with additional instructions which, when executed by the at least one processor, further cause the first computing system to cause the endpoint device to output the indicator at least in part by causing the endpoint device to output an annotation to a displayed representation of the reference within the first content, the annotation indicative of the update.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the disclosure. Accordingly, the foregoing description and drawings are by way of example only.

Various aspects of the present disclosure may be used alone, in combination, or in a variety of arrangements not specifically discussed in the embodiments described in the foregoing and is therefore not limited in this application to the details and arrangement of components set forth in the foregoing description or illustrated in the drawings. For example, aspects described in one embodiment may be combined in any manner with aspects described in other embodiments.

Also, the disclosed aspects may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc. in the claims to modify a claim element does not by itself connote any priority, precedence or order of one claim element over another or the temporal order in which acts of a method are performed, but are used merely as labels to distinguish one claimed element having a certain name from another element having a same name (but for use of the ordinal term) to distinguish the claim elements.

Also, the phraseology and terminology used herein is used for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A method, comprising:
storing, by a computing system, data indicating that first content accessible by an endpoint device includes a reference to second content of a first application hosted on a remote computing device;
receiving, by the computing system, an indication of an update to the second content; and
sending, by the computing system, a notification configured to cause the endpoint device to display, within a representation of the first content that includes the reference but not the second content, an annotation to the reference, the annotation indicative of the update to the second content.

2. (canceled)

3. The method of claim 1, wherein:
receiving the indication of the update comprises receiving the indication from a first agent of the first application; and
sending the notification comprises sending the notification to a second agent of a second application that is configured to provide the endpoint device with access to the first content.

4. The method of claim 3, further comprising:
receiving, by the computing system from the second agent, a request to register use of the reference to the second content by the first content; and
storing, by the computing system, the data in response to the request.

5. The method of claim 4, wherein the first application is configured to provide the endpoint device with access to the second content.

6. The method of claim 3, wherein the computing system sends the notification to the second agent in response to receiving the indication of the update from the first agent.

7. The method of claim 3, further comprising:
storing, by the computing system and based at least in part on the indication of the update received from the first agent, annotation data; and
receiving, by the computing system from second agent, a request to receive stored annotation data for the second content;
wherein sending the notification comprises sending the stored annotation data to the second agent in response to the request.

8. The method of claim 1, wherein:
the first application is configured to provide the endpoint device with access to the first content and the second content;
receiving the indication of the update comprises receiving the indication from a first agent of the first application; and
sending the notification comprises sending the notification to a second agent of the first application.

9. The method of claim 8, further comprising:
receiving, by the computing system from the second agent, a request to register use of the reference to the second content by the first content; and
storing, by the computing system, the data in response to the request.

10. A system, comprising:
at least one processor; and
at least one computer-readable medium encoded with instructions which, when executed by the at least one processor, cause the system to:
store data indicating that first content accessible by an endpoint device includes g a reference to second content of a first application hosted on a remote computing device,
receive an indication of an update to the second content, and
send a notification configured to cause the endpoint device to display, within a representation of the first content that includes the reference but not the second content, an annotation to the reference, the annotation indicative of the update to the second content.

11. (canceled)

12. The system of claim 10, wherein the at least one computer-readable medium is further encoded with additional instructions which, when executed by the at least one processor, further cause the system to:
receive the indication of the update comprises receiving the indication from a first agent of the first application; and
send the notification comprises sending the notification to a second agent of a second application that is configured to provide the endpoint device with access to the first content.

13. The system of claim 12, wherein the at least one computer-readable medium is further encoded with additional instructions which, when executed by the at least one processor, further cause the system to:
receive, from the second agent, a request to register use of the reference to the second content by the first content; and
store the data in response to the request.

14. The system of claim 13, wherein the first application is configured to provide the endpoint device with access to the second content.

15. The system of claim 12, wherein the at least one computer-readable medium is further encoded with additional instructions which, when executed by the at least one processor, further cause the system to:
send the notification to the second agent in response to receiving the indication of the update from the first agent.

16. The system of claim 12, wherein the at least one computer-readable medium is further encoded with additional instructions which, when executed by the at least one processor, further cause the system to:
store, based at least in part on the indication of the update received from the first agent, annotation data;
receive, from second agent, a request to receive stored annotation data for the second content; and
send the stored annotation data to the second agent in response to the request.

17. The system of claim 10, wherein the first application is configured to provide the endpoint device with access to the first content and the second content, and the at least one computer-readable medium is further encoded with additional instructions which, when executed by the at least one processor, further cause the system to:
receive the indication of the update from a first agent of the first application; and
send the notification to a second agent of the first application.

18. The system of claim 17, wherein the at least one computer-readable medium is further encoded with additional instructions which, when executed by the at least one processor, further cause the system to:
receive, from the second agent, a request to register use of the reference to the second content by the first content; and
store the data in response to the request.

19. A method, comprising:
sending, by a first computing system to a second computing system, a request to register that first content accessible by an endpoint device includes a reference to second content of an application hosted on a remote computing device;
receiving, by the first computing system from the second computing system, a notification of an update to the second content; and
causing, by the first computing system and in response to receiving the notification, the endpoint device to display, within a representation of the first content that includes the reference but not the second content, an annotation to the reference, the annotation indicative of the update.

20. (canceled)

21. The method of claim 19, wherein the reference comprises text.

22. The method of claim 1, wherein the reference comprises text.

23. The system of claim 10, wherein the reference comprises text.
